(19) United States
(12) Patent Application Publication
(10) Pub. No.: US 2025/0144727 A1
(43) Pub. Date: May 8, 2025

(54) AUTOMATED STRUT SHEARING MACHINE

(71) Applicant: MILWAUKEE ELECTRIC TOOL CORPORATION, Brookfield, WI (US)

(72) Inventors: Christopher T. Larson, Waukesha, WI (US); Anthony P. Coffey, Lisbon, WI (US); Richard J. Rebro, West Allis, WI (US); Daniel R. Schrader, Oconomowoc, WI (US); Christopher R. Nelson, Lindenhurst, IL (US); Matthew J. Essenmacher, Mount Pleasant, WI (US); Christopher L. Seiler, East Troy, WI (US); Matthew J. Sterr, West Allis, WI (US)

(21) Appl. No.: 18/728,000

(22) PCT Filed: Jan. 11, 2023
(86) PCT No.: PCT/US2023/010566

§ 371 Date: Jul. 10, 2024

Related U.S. Application Data
(60) Provisional application No. 63/298,507, filed on Jan. 11, 2022.

(51) Int. Cl. B23D 23/04; B23D 36/00

(52) U.S. Cl. CPC B23D 23/04; B23D 36/0033

(57) ABSTRACT

A shearing machine includes a support frame, a magazine including a platform having a top surface extending between a processing end and a loading end, the magazine configured to support a plurality of struts on the top surface, a separator assembly configured to separate a separated strut from the plurality of struts, the separated strut defining a strut width, a feed assembly configured to move the separated strut relative to the support frame along a feed axis defining a feed direction, a shearing assembly disposed at the processing end, the shearing assembly including a die assembly operable to shear a strut segment from the separated strut, and a controller configured to control the separator assembly, the feed assembly, and the shearing assembly to automatically separate the separated strut, move the separated strut, and shear the strut segment from the separated strut to a predetermined length.

### CROSS-REFERENCE TO RELATED APPLICATIONS

This application claims priority to co-pending U.S. Provisional Patent Application No. 63/298,507, filed on Jan. 11, 2022, the entire content of which is incorporated herein by reference.

### BACKGROUND

The present disclosure relates to shearing machines, and more particularly to machines for shearing metal studs to a desired length. Shearing of metal struts for construction of structures is often completed with handheld tools requiring handling by an operator. The length of strut to be cut may be difficult to handle by one user, leading to inefficiencies and inaccuracies.

### SUMMARY

The present disclosure provides, among other things, an automated strut shearing assembly able to shear metal strut at various lengths with limited operator engagement due to the automated process carried out by the strut shearing machine.

For example, the present disclosure provides, in one aspect, a shearing machine configured to shear one of a plurality of struts. The shearing machine includes a support frame, a magazine including a platform having a top surface extending between a processing end and a loading end, the magazine configured to support the plurality of struts on the top surface, a separator assembly configured to separate a separated strut from the plurality of struts, the separated strut defining a strut width, a feed assembly configured to move the separated strut relative to the support frame along a feed axis defining a feed direction, a shearing assembly disposed at the processing end, the shearing assembly including a die assembly operable to shear a strut segment from the separated strut, and a controller configured to control the separator assembly, the feed assembly, and the shearing assembly to automatically separate the separated strut, move the separated strut, and shear the strut segment from the separated strut to a predetermined length.

In some embodiments, the shearing machine includes a user interface configured to receive a user input, and the controller is configured to control the separator assembly, the feed assembly, and the shearing assembly based upon the user input, and the user input includes the predetermined length.

In some embodiments, the user input includes a cut list including a plurality of predetermined lengths, and the controller is configured to control the separator assembly, the feed assembly, and the shearing assembly based on the cut list to automatically produce a plurality of strut segments from the plurality of struts.

In some embodiments, the separator assembly includes a wedge driven by a wedge actuator.

In some embodiments, the die assembly is a first die assembly having a first profile, the shearing assembly further includes a second die assembly having a second profile different than the first profile, and the first die assembly and the second die assembly are interchangeable.

In some embodiments, the shearing assembly includes a die support table that is slidable relative to the support frame, the die support table supporting the first die assembly and the second die assembly with the first die assembly arranged adjacent the second die assembly in a lateral direction perpendicular to the feed direction such that the first die assembly or the second die assembly are selectively alignable with the feed axis.

In some embodiments, the first die assembly and the second die assembly each include an actuator coupled to a shearing die, and the actuator is arranged at an angle relative to the top surface of the platform.

In some embodiments, the angle is a 45 degree angle.

In some embodiments, the feed assembly includes a gripper head with a first jaw and a second jaw spaced from the first jaw, the first jaw and the second jaw movable between a first position defining a first distance between the first jaw and the second jaw that is larger than the strut width of the separated strut and a second position defining a second distance between the first jaw and the second jaw that is substantially equivalent to or less than the strut width of the separated strut.

In some embodiments, the shearing machine includes a lateral actuator disposed between the processing end and the loading end, the lateral actuator configured to move the plurality of struts in a lateral direction substantially perpendicular to the feed direction.

In some embodiments, the shearing machine includes a punch assembly including a punch tool configured to form one or more holes in the separated strut.

In some embodiments, the controller is configured to control the punch assembly to form one or more holes in the separated strut prior to operation of the shearing assembly, and wherein, after operation of the shearing assembly, the one or more holes are located on the strut segment.

The present disclosure provides, in another aspect, a shearing machine configured to shear one of a plurality of struts. The shearing machine includes a support frame, a magazine configured to support the plurality of struts, a separator assembly configured to separate a separated strut from the plurality of struts, a feed assembly configured to move the separated strut relative to the support frame along a feed axis defining a feed direction, a shearing assembly including a die assembly operable to shear the separated strut, a user interface, and a controller in communication with the user interface to receive a cut list from the user interface, the cut list including a plurality of cut lengths. The controller is configured to control the separator assembly, the feed assembly, and the shearing assembly to automatically shear a plurality of strut segments from the plurality of struts, each of the plurality of strut segments having a length corresponding to one of the plurality of cut lengths from the cut list.

In some embodiments, the controller is configured to determine an order of cuts from the plurality of cut lengths.

In some embodiments, the order of cuts includes a first cut having a first cut length, and the controller is configured to operate the shearing machine to shear the separated strut into a first strut segment having the first cut length, and then to remove the first cut from the cut list.

In some embodiments, the controller is configured to determine a remaining strut length of the separated strut and to determine if one of the plurality of cut lengths remaining in the cut list is less than the remaining strut length.

In some embodiments, the controller is configured to operate the shearing machine to discard the separated strut if the controller determines that the remaining strut length is less than each of the plurality of cut lengths remaining in the cut list.

The present disclosure provides, in another aspect, a method of operating a shearing machine configured to shear one of a plurality of struts. The method includes separating a separated strut from the plurality of struts, advancing the separated strut in a feed direction, shearing the separated strut to form a first strut segment having a first length, further advancing the separated strut in the feed direction, and shearing the separated strut to form a second strut segment having a second length.

In some embodiments, the method further includes forming a hole in the separated strut prior to shearing the separated strut.

In some embodiments, the method further includes inputting a cut list to a controller of the shearing machine, the cut list including the first length and the second length.

Other features and aspects of the disclosure will become apparent by consideration of the following detailed description and accompanying drawings. Any feature(s) described herein in relation to one aspect or embodiment may be combined with any other feature(s) described herein in relation to any other aspect or embodiment as appropriate and applicable.

### BRIEF DESCRIPTION OF THE DRAWINGS

FIG. 1 is a perspective view of a shearing machine according to an embodiment of the present disclosure.

FIG. 2 is another perspective view of the shearing machine of FIG. 1, with detail views of a separator assembly of the shearing machine.

FIG. 3 is another perspective view of the shearing machine of FIG. 1, with a detail view of a feed assembly of the separator machine.

FIGS. 4A-4B are perspective views illustrating a punch assembly of the shearing machine of FIG. 1.

FIG. 5 is a perspective view of a portion of the shearing machine of FIG. 1, with a detail view of a strut alignment assembly of the shearing machine.

FIG. 6 illustrates an exemplary user interface of the shearing machine of FIG. 1.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

### DETAILED DESCRIPTION

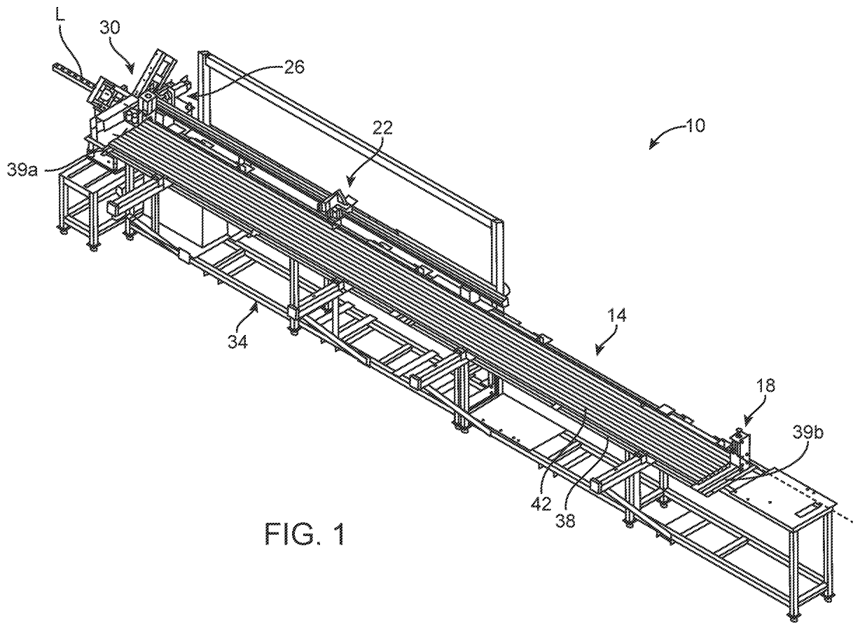

FIG. 1 illustrates a shearing machine 10 according to an embodiment of the present disclosure. The shearing machine 10 includes a magazine 14, a separator assembly 18, a feed assembly 22, a punch assembly 26, and a shearing assembly 30, each supported on a support frame 34. As described in greater detail below, the feed assembly 22 is operable to automatically feed steel struts 42 from the magazine 14 in a feed direction along a longitudinal feed axis L, for processing by the punch assembly 26 and the shearing assembly 30, thereby producing pre-fabricated sections of steel strut, cut to a desired length, and punched with one or more hole(s) at specified locations.

The illustrated magazine 14 includes a platform 38, which extends longitudinally from a processing end 39a, adjacent the punch assembly 26 and shearing assembly 30, and a loading end 39b opposite the processing end 39a. The platform 38 of the magazine 14 is sized and shaped to accommodate a plurality of uncut steel struts 42. For example, the illustrated platform 38 accommodates up to ten sections of ten-foot long, single channel struts 42, positioned side-by-side in a single layer. The platform 38 may also accommodate up to five sections of ten-foot long, back-to-back or double channel struts, also positioned side-by-side in a single layer. In other embodiments, the platform 38 may be larger or smaller to accommodate a desired size and/or number of struts 42.

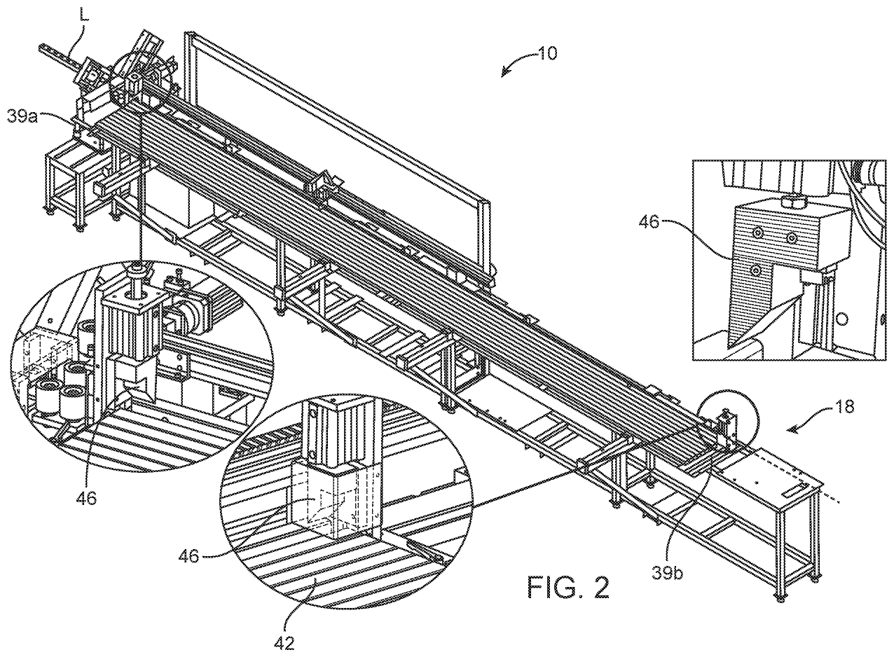

With reference to FIG. 2, the illustrated separator assembly 18 include two separators 46—one located proximate the processing end 39a, and the other located proximate the loading end 39b. Each separator 46 includes a wedge driven by an actuator (e.g., a pneumatic actuator). The wedges are movable by their respective actuators in a direction perpendicular to the feed axis L to separate a single strut 42 from the remaining struts 42 in the magazine 14. In other embodiments, each separator may include other structures capable of separating a single strut from the remaining struts in the magazine.

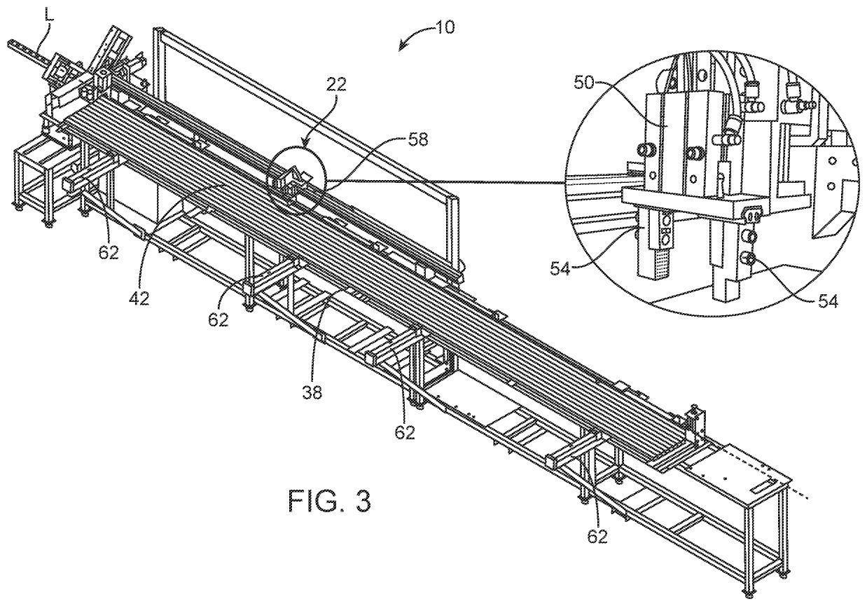

With reference to FIG. 3, the illustrated feed assembly 22 includes a gripper head 50 with a pair of pneumatically-actuated jaws 54. The jaws 54 are operable to selectively grip the separated strut 42. Each of the jaws may include a pad coupled to the jaw, for instance, an elastomeric pad to grip the separated strut with additional frictional force. A drive mechanism 58 (e.g., a linear motor or any other suitable mechanism) is provided to move the gripper head 50 linearly along the feed axis L, and thereby move the strut 42 along the feed axis L. In some embodiments, the feed assembly 22 may include other mechanisms for advancing the separated strut along the feed axis L, including but not limited to servo-controlled rollers. Once the selected strut 42 is advanced and processed, a plurality of magazine actuators 62 (e.g., pneumatic cylinders) may advance the remaining struts 42 in the magazine 14 laterally toward the separator assembly 18 for subsequent processing.

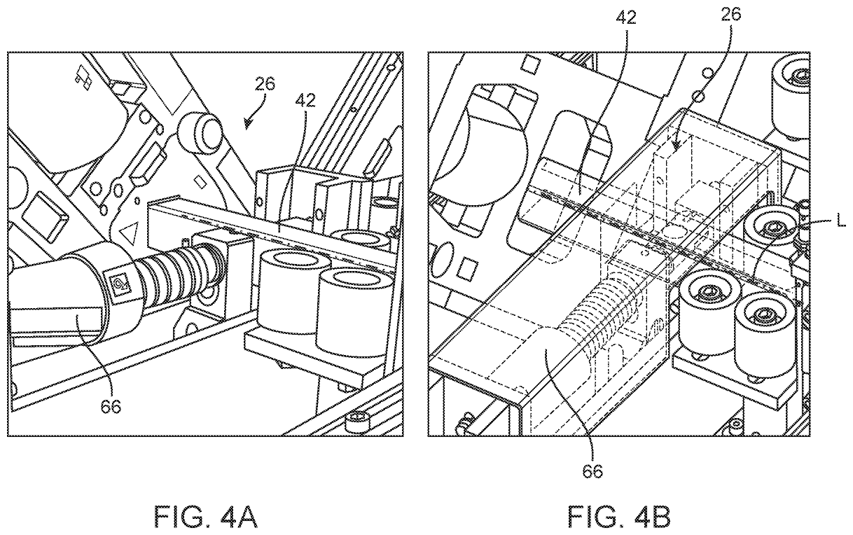

Referring to FIGS. 4A-B, the punch assembly 26 includes a punch tool 66 (e.g., a pneumatically or hydraulically powered punch tool) oriented perpendicular to the feed axis L. The punch tool 66 is operable to selectively punch one or more holes in the strut 42 before the strut 42 is cut by the shearing assembly 30. Thus, the strut 42 can both be punched and cut in a single pass through the shearing machine 10. The punch tool 66 may include interchangeable punch sizes to allow the size of the hole to be customized to suit a particular application. The holes may have a circular, obround, or other profiles.

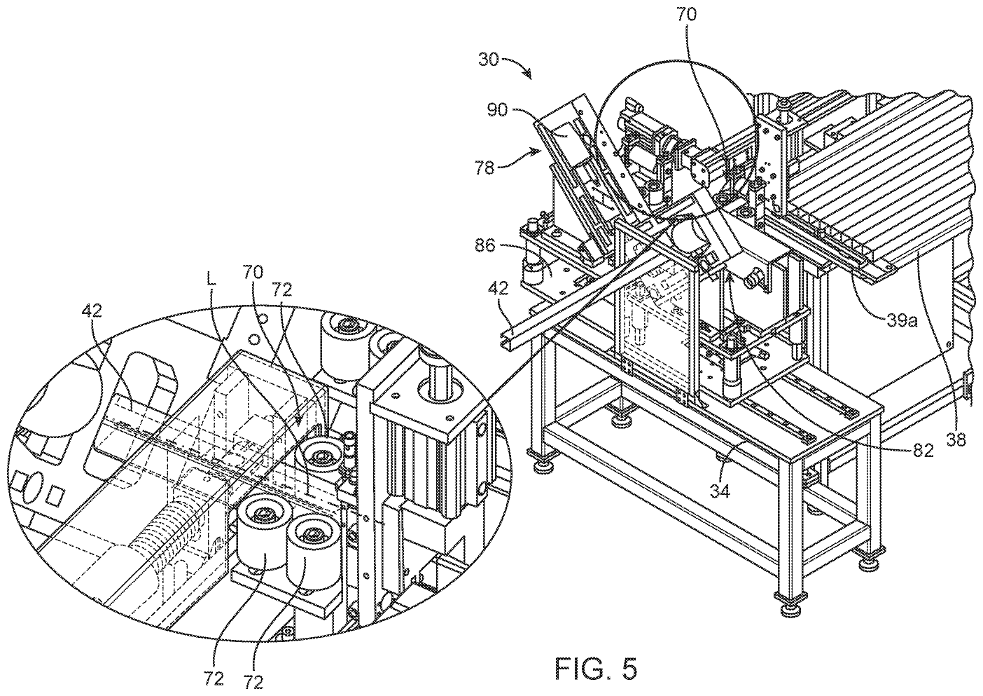

With reference to FIG. 5, the shearing machine 10 further includes a guide roller assembly 70 located adjacent the processing end 39a of the platform 38. The guide roller assembly 70 includes pairs of rollers 72 that engage opposite sides of the strut 42 being processed to center the strut 42 on the feed axis L and thereby align the strut 42 with the shearing assembly 30.

With continued reference to FIG. 5, the shearing assembly 30 includes a first die assembly 78 and a second die assembly 82. The die assemblies 78, 82 are supported on a die support table 86, which is adjustably positioned on the support frame 34. In particular, the illustrated die support table 86 is slidable along the support frame 34 between a first position, in which the first die assembly 78 is aligned with the feed axis L and a second position, in which the second die assembly 82 is aligned with the feed axis L. The first die assembly 78 in the illustrated embodiment has a pattern for shearing back-to-back struts, while the second die assembly 82 has a pattern for shearing single struts. Thus, by moving the die support table 86, the appropriate die assembly 78, 82 can be selected for the type of struts 42 being processed.

In the illustrated embodiment, each of the die assemblies 78, 82 includes an actuator 90 (e.g., a hydraulic actuator) that drives a blade (not shown) to shear the strut 42 at a desired cut length. The actuators 90 are oriented at 45-degree angles relative to the top surface of the platform 38 in the illustrated embodiment. This provides an optimal cut angle to cleanly and accurately shear the strut 42. In other embodiments, the actuators may be oriented at other angles relative to the top surface.

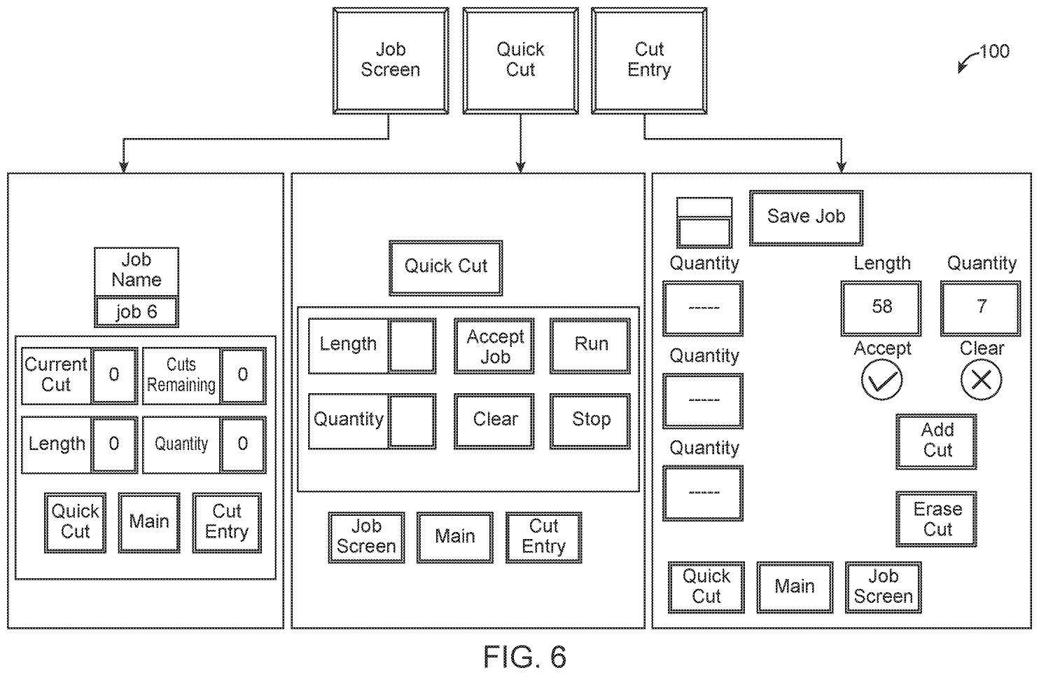

FIG. 6 illustrates an exemplary user interface 100 of the shearing machine 10. The user interface 100 may include a display and inputs (e.g., a touch screen with virtual buttons, physical buttons, or the like), allowing a user to input a cut list with desired quantities and lengths to be cut from the uncut struts 42. The user interface 100 communicates with a controller (e.g., including a microprocessor, non-transitory memory storing software for carrying out the processes described herein, and other electrical and electronic components for controlling operation of the shearing machine 10). The shearing machine 10 may include other indicators, such as indicators such as visual indicators (e.g., LEDs) or auditory indicators (e.g., buzzers, bells, etc.) that indicate alarms, operation completion, etc.

In operation, a user loads the magazine 14 of the shearing machine 10 with struts 42 to be cut (e.g., loading up to ten single struts or five back-to-back struts). The user then provides the shearing machine 10 with a cut list (e.g., via the user interface 100) and initiates operation of the shearing machine 10.

Once operation is initiated, the controller of the shearing machine 10 may automatically determine a most efficient order of cuts. For example, in one embodiment, the controller reads the cut list to determine the longest section able to be cut from the first strut 42 in the magazine 14, then initializes a cutting operation to cut this section.

In particular, the controller operates the separator assembly 18 to separate the first strut 42 (i.e., the separated strut) from the remaining struts 42 in the magazine 14 to provide clearance for the jaws 54 of the gripper head 50. The controller then operates the feed assembly 22 to advance the first strut 42 along the feed axis L toward the shearing assembly 30 (e.g., by gripping the first strut 42 with the jaws 54 and moving the gripper head 50). If holes are desired in the cut section of the strut, the feed assembly 22 is controlled to advance the first strut 42 to a first location corresponding with a target location for a first hole. The controller then stops the feed assembly 22 and operates the punch tool 66 to punch the first hole.

If another hole is desired, the controller operates the feed assembly 22 to further advance the first strut 42 to a second location corresponding with a target location for the second hole, and the process repeats for any additional desired holes. Finally, the controller controls the feed assembly 22 to advance the first strut 42 to a position corresponding with the desired cut length for the first cut in the cut list. Once the first strut 42 is properly positioned at the desired length for the first cut in the cut list, the controller operates the shearing assembly 30 to shear the first strut 42 with the selected die assembly 78, 82.

After cutting this longest section, the controller then removes the completed cut from the cut list and determines the next longest section able to be cut from the remaining length of the first strut 42. The controller repeats this process until no remaining cuts exist on the cut list with a length less than the remaining length of the first strut, plus a minimum scrap offset value, which is the minimum amount of scrap length remaining (e.g., the distance between the front most position of the gripper head 50 and the shearing assembly 30. The controller then discards the remaining scrap (e.g., by moving the scrap piece with the feed assembly 22 in an opposite direction until the scrap piece falls into a scrap collection bin). In some embodiments, the magazine 14 may include an opening in the platform 38 to receive the scrap, and the scrap collection bin may be positioned below the opening.

The controller then operates the magazine actuators 62 to advance the remaining struts 42 laterally along the magazine 14. The controller then reads the cut list to determine the longest section able to be cut from the second strut 42 in the magazine 14, then initializes a cutting operation to cut this section in the same manner discussed above. The process repeats until the cut list is completed, or until no struts 42 remain in the magazine 14. If the magazine 14 is depleted, the user may reload the magazine to continue operation.

In one example, a shearing machine embodying aspects of the present disclosure may have the following characteristics. The shearing machine is capable of shearing both a single Unistrut having a width of 1⅝″ and a height of 1⅝″ and a back-to-back Unistrut having a width of 3¼″ and a height of 1⅝″. The shearing machine 10 is also capable of punching a hole with a diameter of 9/16″ in a single Unistrut. The shearing machine 10 is capable of performing both the punch operation and the shear operation in one pass, that is, the punching operation is performed and then the shearing operation is performed without having to transfer the strut to another machine. The shearing machine 10 can hold up to ten single Unistruts or five back-to-back Unistruts. The shearing machine 10 includes controls (e.g., a controller) that feed and align the strut with the shearing assembly 30, measure the cut length, perform a cut count in which the number of cuts are counted, transport the cut section of strut to a collection table via a conveyor, move scrap sections having a length of twenty-four inches or less to a separate scrap collection bin, prompt or alert a user when the cut list is complete, material (e.g., additional struts) needs to be loaded onto the magazine, or larger scrap (e.g., sections having a length greater than twenty-four inches) needs to be manually cleared. The shearing machine 10 is operable by one operator, to input a cut list, load struts into the magazine to be cut, and remove larger scrap.

In other embodiments, the shearing machine 10 may be able to shear other configurations of extruded products having different dimensions than those described above. The shearing machine 10 may be configured to complete other punch operations of different sized holes having different profiles. The shearing machine 10 may be sized to accommodate different quantities of struts having lengths greater than or less than ten feet. The shearing machine 10 may be capable of other processing operations to be completed prior to or after the shearing operation. The shearing machine 10 may receive other inputs from an operator or output other information and prompts to the operator.

Although the disclosure has been described in detail with reference to certain preferred embodiments, variations and modifications exist within the scope and spirit of one or more independent aspects of the disclosure as described.

Various features of the disclosure are set forth in the following claims.

What is claimed is:

1. A shearing machine configured to shear one of a plurality of struts, the shearing machine comprising:
a support frame;
a magazine including a platform having a top surface extending between a processing end and a loading end, the magazine configured to support the plurality of struts on the top surface;
a separator assembly configured to separate a separated strut from the plurality of struts, the separated strut defining a strut width;
a feed assembly configured to move the separated strut relative to the support frame along a feed axis defining a feed direction;
a shearing assembly disposed at the processing end, the shearing assembly including a die assembly operable to shear a strut segment from the separated strut; and
a controller configured to control the separator assembly, the feed assembly, and the shearing assembly to automatically separate the separated strut, move the separated strut, and shear the strut segment from the separated strut to a predetermined length.

2. The shearing machine of claim 1, further comprising a user interface configured to receive a user input, wherein the controller is configured to control the separator assembly, the feed assembly, and the shearing assembly based upon the user input, and wherein the user input includes the predetermined length.

3. The shearing machine of claim 2, wherein the user input includes a cut list including a plurality of predetermined lengths, and wherein the controller is configured to control the separator assembly, the feed assembly, and the shearing assembly based on the cut list to automatically produce a plurality of strut segments from the plurality of struts.

4. The shearing machine of claim 1, wherein the separator assembly includes a wedge driven by a wedge actuator.

5. The shearing machine of claim 1, wherein the die assembly is a first die assembly having a first profile, wherein the shearing assembly further includes a second die assembly having a second profile different than the first profile, and wherein the first die assembly and the second die assembly are interchangeable.

6. The shearing machine of claim 5, wherein the shearing assembly includes a die support table that is slidable relative to the support frame, the die support table supporting the first die assembly and the second die assembly with the first die assembly arranged adjacent the second die assembly in a lateral direction perpendicular to the feed direction such that the first die assembly or the second die assembly are selectively alignable with the feed axis.

7. The shearing machine of claim 5, wherein the first die assembly and the second die assembly each include an actuator coupled to a shearing die, and wherein the actuator is arranged at an angle relative to the top surface of the platform.

8. The shearing machine of claim 7, wherein the angle is a 45 degree angle.

9. The shearing machine of claim 1, wherein the feed assembly includes a gripper head with a first jaw and a second jaw spaced from the first jaw, the first jaw and the second jaw movable between a first position defining a first distance between the first jaw and the second jaw that is larger than the strut width of the separated strut and a second position defining a second distance between the first jaw and the second jaw that is substantially equivalent to or less than the strut width of the separated strut.

10. The shearing machine of claim 1, further comprising a lateral actuator disposed between the processing end and the loading end, the lateral actuator configured to move the plurality of struts in a lateral direction substantially perpendicular to the feed direction.

11. The shearing machine of claim 1, further comprising a punch assembly including a punch tool configured to form one or more holes in the separated strut.

12. The shearing machine of claim 1, wherein the controller is configured to control the punch assembly to form one or more holes in the separated strut prior to operation of the shearing assembly, and wherein, after operation of the shearing assembly, the one or more holes are located on the strut segment.

13. A shearing machine configured to shear one of a plurality of struts, the shearing machine comprising:
a support frame;
a magazine configured to support the plurality of struts;
a separator assembly configured to separate a separated strut from the plurality of struts;
a feed assembly configured to move the separated strut relative to the support frame along a feed axis defining a feed direction;
a shearing assembly including a die assembly operable to shear the separated strut;
a user interface; and
a controller in communication with the user interface to receive a cut list from the user interface, the cut list including a plurality of cut lengths,
wherein the controller is configured to control the separator assembly, the feed assembly, and the shearing assembly to automatically shear a plurality of strut segments from the plurality of struts, each of the plurality of strut segments having a length corresponding to one of the plurality of cut lengths from the cut list.

14. The shearing machine of claim 13, wherein the controller is configured to determine an order of cuts from the plurality of cut lengths.

15. The shearing machine of claim 14, wherein the order of cuts includes a first cut having a first cut length, and wherein the controller is configured to operate the shearing machine to shear the separated strut into a first strut segment having the first cut length, and then to remove the first cut from the cut list.

16. The shearing machine of claim 15, wherein the controller is configured to determine a remaining strut length of the separated strut and to determine if one of the plurality of cut lengths remaining in the cut list is less than the remaining strut length.

17. The shearing machine of claim 16, wherein the controller is configured to operate the shearing machine to discard the separated strut if the controller determines that the remaining strut length is less than each of the plurality of cut lengths remaining in the cut list.

18. A method of operating a shearing machine configured to shear one of a plurality of struts, the method comprising:
separating a separated strut from the plurality of struts;
advancing the separated strut in a feed direction;
shearing the separated strut to form a first strut segment having a first length;
further advancing the separated strut in the feed direction; and
shearing the separated strut to form a second strut segment having a second length.

19. The method of claim 18, further comprising forming a hole in the separated strut prior to shearing the separated strut.

20. The method of claim 18, further comprising inputting a cut list to a controller of the shearing machine, the cut list including the first length and the second length.
